(19) United States
(12) Patent Application Publication
(10) Pub. No.: US 2005/0249929 A1
(43) Pub. Date: Nov. 10, 2005

(54) Digitally printed surface covering

(76) Inventors: David P. Reichwein, Elizabethtown, PA (US); Timothy B. Burk, York, PA (US); Matthew S. Myers, Lititz, PA (US); Sunil Ramachandra, Lancaster, PA (US); Fred W. Wise, Windsor, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/093,139

(22) Filed: Mar. 29, 2005

Related U.S. Application Data
(60) Provisional application No. 60/568,426, filed on May 5, 2004.

(51) Int. Cl. B32B 3/10

(52) U.S. Cl. 428/211.1

(57) ABSTRACT

Surface covering having a wood pattern of expensive and/or limited available wood species can be formed by adhering a wood grain of the expensive and/or limited available wood species on a wood substrate of a less expensive, more common wood species substrate. The surface covering can be either solid, engineered wood or a laminate. If the wood grain of the substrate is dark or the wrong color, a pad coat or stain can be interposed between the substrate and the printed wood pattern. The printed wood pattern and/or pad coat can be applied to the substrate, whether wood or other material, in the form of a free-standing film.

This invention is directed to a surface covering having an opaque pad coat interposed between a substrate and a digitally printed print layer, and to a free-standing film having an opaque pad coat interposed between a transparent or translucent film and a digitally printed print layer. The invention also includes printing a wood grain pattern onto a wood substrate to modify the appearance of the substrate and the method of making such a surface covering, as well as the method of making each of the above-identified surface coverings.

### BACKGROUND OF THE INVENTION

Wood floors (solid, engineered wood and laminates) are gaining market share in the flooring sector. The concepts of the present invention apply directly to wood floor manufacturing, as well as other surface coverings including resilient floor coverings. The surface covering business is highly competitive, and marginal cost savings, such as may be afforded by these techniques, may have high dollar implications.

Due to the increased cost and limited availability of some preferred wood species, lower cost methods of meeting the consumer demand are being sought.

Flexography is an offset technique where the printing plates or cylinders are made from rubber or photopolymers. The printing has been accomplished by the transfer of ink from the raised surface of the printing plate to the surface of the material being printed. The rotogravure method of printing uses a print cylinder with thousands of tiny cells which are below the surface of the printing cylinder. The ink is transferred from the cells when the print cylinder is brought into contact with the pressure sensitive label at the impression roll. Printing inks for flexography or rotogravure include solvent based inks, water based inks, and radiation cured inks. While rotogravure and flexography printing does provide acceptable image quality, these two printing methods require expensive and time-consuming preparation of print cylinders or printing plates which make printing jobs of less than 100,000 units expensive as the setup cost and the cost of the cylinders or printing plates is typically depreciated over the size of the print job.

Recently, digital printing has become a viable method for the printing of information on packages. The term “digital printing” refers to the electronic digital characters or electronic digital images that can be printed by an electronic output device capable of translating digital information. The two main digital printing technologies are ink jet and electrophotography.

The introduction of piezo impulse drop-on-demand (DOD) and thermal DOD ink jet printers in the early 1980's provided ink jet printing systems. These early printers were very slow, and the ink jet nozzles often clogged. In the 1990's Hewlett Packard introduced the first monochrome ink jet printer, and shortly thereafter, the introduction of color, wide format ink jet printers enabled businesses to enter the graphic arts market. Today, a number of different ink jet technologies are being used for packaging, desktop, industrial, commercial, photographic, and textile applications.

In piezo technology, a piezo crystal is electrically excited to create pressure waves, which eject ink from the ink chamber. The ink can be electrically charged and deflected in a potential field, allowing the different characters to be created. More recent developments have introduced DOD multiple jets that utilize conductive piezo ceramic material which, when charged, increases the pressure in the channel and forces a drop of ink from the end of the nozzle. This allows for very small droplets of ink to form and be delivered at high speed at very high resolution, approximately 1,000 dpi printing.

Until recently, the use of color pigments in jet inks was uncommon. However, this is changing rapidly. Submicron pigments were developed in Japan for ink jet applications. Use of pigments allows for more temperature resistant inks required for thermal ink jet printers and laminations. Pigmented water-based jet inks and UV-curable jet inks are commercially available. Pigmented inks have greater lightfastness and water-resistance.

The concept of digital printing for decorative applications exists in prior art, however, the present invention relates to new techniques and applications. Among these are the use of evolving digital printing hardware for specific surface coverings, particularly flooring, applications. More specifically, these include the use of inkjet and electrostatic based printers for unique application in the resilient tile and sheet product areas, as well as wood structures and accessories.

### SUMMARY OF THE INVENTION

One method is to change the appearance of a lower costing wood species to resemble the appearance of the higher cost wood species, which is in demand. This can be accomplished by printing the grain pattern of the preferred wood species on a substrate of the less costly species.

If the species forming the wood substrate has a grain pattern that is substantially uniform in color, i.e. the winter growth wood is substantially the same shade as the summer growth wood, the grain pattern of the desired species can be printed directly on the substrate. Otherwise, it may be necessary to apply a pad coat or other layer to the substrate prior to printing the desired wood grain pattern onto the substrate.

Pad coats are typically opaque and white or light in color. If the pad coat has a smooth, flat surface, the wood pattern can be printed on the pad coat with a rotogravure press, as well as with digital printing.

The present invention can be used to produce resilient tiles and sheet goods with custom images. Pad coats are useful to hide the tile and sheet substrates.

The printing of simulated wood patterns on vinyl and/or paper substrates for processing engineered/laminate wood structures avoids the necessity of inventorying large quantities of melamine impregnated paper. This is desirable because the melamine impregnated paper has a finite shelf life.

Directly printing on unfinished wood substrates can efficaciously convert natural color and/or graining characteristics of one species into other species, e.g., white oak to red oak. This has the potential for significant cost savings in the manufacturing processes associated with producing engineered wood and laminate products (e.g., elimination of intermediate film processes).

### DETAILED DESCRIPTION OF THE INVENTION

Some more expensive wood, particularly hardwoods, are becoming difficult to obtain. By printing the wood grain pattern of a more expensive wood on the substrate of a less expensive wood, the appearance of the more expensive wood can be simulated. If the wood grain of the less expensive wood is relatively light, the grain pattern of the more expensive wood, particularly dark wood, can be printed directly onto the less expensive wood substrate.

Optionally, an opaque pad coat can be applied to the wood substrate. The pad coat may be white or the color of natural wood. If the pad coat is white, it may be necessary to apply a stain to the pad coat to match the color of the wood to be simulated. The pad coat can be applied by any known method, including digital printing.

Once the pad coat is applied and stained, if necessary, the wood grain of the desired wood species is printed on the pad coat. One preferred method of printing the wood grain pattern is to use digital printing. The wood grain pattern can be printed on the pad coat with a screen printer or rotogravure printer.

The appearance of the wood can be further changed or the properties of the surface covering improved by interposing a primer sealant, a filler layer or a stain between the wood substrate and the printed wood grain pattern.

In another embodiment, the pad coat and digitally printed layer can be in the form of a free-standing film, which film can be laminated to a substrate to form a surface covering. The free-standing film can also include a transparent or translucent film with the print layer being interposed between the transparent or translucent film and the pad coat. When laminated to a substrate, the transparent or translucent film can act as a wear layer.

Digital printing ink is characterized by a viscosity and particle size that permits application with an ink jet. The digital printing ink can be water-based, solvent-based or 100% solids. The 100% solids inks are typically UV cured.

A surface covering can be made by forming a base, applying an opaque pad coat to the base, and digitally printing a print layer onto the pad coat. The pad coat may be applied with any known method including a reverse roll coater or by digitally printing the pad coat. If the surface covering is a tile, the base is frequently made by forming a sheet of tile base material, applying any decorative layer and/or wear layer and then cutting or punching the tile from the sheet.

Recycling of the tile base material is easier if the sheet is cut prior to applying the pad coat and print layer. In this manner, any chipped or broken tile bases can be recycled without removing the pad coat or contaminating the tile base material with the pad coat material. To avoid printing chipped or broken tiles, the pad coated tile base sheet can be cut before the pad coat is printed.

Since the application of the digital print ink can be controlled by a computer, the digital pattern can be repeated in a looped pattern or be non-repeating. The non-repeating pattern is obtained by using a computer algorithm. By using an algorithm to generate the pattern as it is being applied, the repeat length can be infinite.

If the pattern loops or repeats, it is desirable to have the pattern on each side of the pattern splice merge so that there is no abrupt, noticeable change or break in the pattern. Depending on how much computer memory is used, the length of the loop can be varied and easily exceed 60 or 96 inches.

The pattern can also be varied by developing a number of pattern segments with similar designs at the beginning and end points. Then the segments can be randomly selected to vary the pattern without an abrupt or noticeable change or break in the pattern.

The pattern can also be varied by moving the print head while it is applying the ink. This results in a dynamic pattern. If the print head is moved in a random manner or the computer is programmed to randomly select loop segments or the print images are randomly selected, a random pattern results.

1. A surface covering comprising a wood substrate and a printed wood grain pattern adhered to the wood substrate.

2. The surface covering of claim 1, wherein a layer selected from the group consisting of a primer sealant, a filler layer, a pad coat and a stain is interposed between the substrate and the wood grain pattern.

3. The surface covering of claim 1, wherein a pad coat is interposed between the substrate and the wood grain pattern, the pad coat being opaque and having a smooth, flat surface.

4. The surface covering of claim 3, wherein the color of the pad coat is selected from the group consisting of white and shades of natural wood.

5. The surface covering of claim 3, wherein the wood grain pattern is selected from the group consisting of a rotogravure printed pattern and a digitally printed pattern.

6. The surface covering of claim 1, wherein the wood grain pattern is a digitally printed pattern applied directly to the wood substrate.

7. The surface covering of claim 1, wherein the wood grain pattern is a digitally printed pattern and wherein the digitally printed layer comprises a looped pattern.

8. The surface covering of claim 7, wherein the looped pattern is continuous having no abrupt change in the printed pattern.

9. The surface covering of claim 7, wherein the looped pattern is formed by combining a plurality of pattern segments having different designs.

10. The surface covering of claim 9, wherein the plurality pattern segments are randomly selected.

11. The surface covering of claim 1, wherein the wood grain pattern is a digitally printed pattern and wherein the printed wood grain pattern does not repeat.

12. The surface covering of claim 1, wherein the wood grain pattern is the grain of a wood species different than the species of the wood substrate.

13. The surface covering of claim 1, wherein a pad coat is adhered to a film, the film and pad coat composite being adhered to the wood substrate.

14. The surface covering of claim 13, wherein the wood grain pattern is interposed between the film and the pad coat.

15. The surface covering of claim 13, wherein the film is interposed between the pad coat and the wood grain pattern.

16. A surface covering comprising a substrate, an opaque pad coat overlying the substrate and a print layer overlying the pad coat, said print layer comprising a digital printing ink.

17. A free-standing film comprising an opaque pad coat and a print layer overlying the pad coat, said print layer comprising a digital printing ink.

18. The free-standing film of claim 17, further comprising a transparent or translucent film, the print layer being interposed between the pad coat and the film.

19. A method of making a surface covering comprising forming a base, applying an opaque pad coat to the base and digitally printing a print layer onto the pad coat.

20. The method of claim 19, wherein the pad coat is digitally printed onto the base.

21. The method of claim 19, wherein the surface covering is a tile and wherein the tile base is formed in a sheet and the sheet is cut into a plurality of tile pieces prior to digitally printing the print layer.

22. The method of claim 21, wherein the tile base is formed in a sheet and the sheet is cut into a plurality of tile pieces prior to applying the pad coat to the individual pieces.
